(19) United States
(12) Patent Application Publication
(10) Pub. No.: US 2022/0318742 A1
(43) Pub. Date: Oct. 6, 2022

(54) Systems, Methods, And Apparatuses For Improved Logistics Predictions

(71) Applicant: McKesson Corporation, Irving, TX (US)

(72) Inventors: Samuel J. Colen, Dallas, TX (US); David H. Hunter, Coppell, TX (US); Ted Michael Stieber, Phoenix, AZ (US)

(21) Appl. No.: 17/502,423

(22) Filed: Oct. 15, 2021

Related U.S. Application Data
(60) Provisional application No. 63/168,900, filed on Mar. 31, 2021.

(51) Int. Cl. G06Q 10/08; G06N 7/00

(52) U.S. Cl. CPC G06Q 10/0833; G06Q 10/08355; G06N 7/00

(57) ABSTRACT

Provided herein are systems, methods, and apparatuses for improved logistics predictions. A computing device may receive a first shipment identifier and first shipment metadata (e.g., expected delivery date/time, etc.). The prediction engine may retrieve data related to a plurality of existing shipments using a same route for delivery as the first shipment. The prediction engine may use at least one survival model to determine an on-time delivery prediction for each of the plurality of existing shipments. The prediction engine may also use the at least one survival model to determine a first on-time delivery prediction for the first shipment. The prediction engine may cause the first shipment metadata to be modified based on the first on-time delivery prediction.

### CROSS-REFERENCE TO RELATED PATENT APPLICATION

This application claims priority to U.S. Provisional App. No. 63/168,900, filed on Mar. 31, 2021, the entirety of which is incorporated by reference herein.

### BACKGROUND

Timely and efficient logistics operations are important for any business that relies on on-time delivery of shipments (e.g., products, parts, etc.), and determining accurate delivery predictions is a challenging task with many facets. While automation has improved many logistics operations, unforeseen events and procedural inefficiencies may still cause substantial problems for shipping senders, shipping recipients, and shipping carriers alike. Moreover, unforeseen events and procedural inefficiencies are difficult to account for when determining accurate delivery predictions. These and other considerations are described herein.

### SUMMARY

It is to be understood that both the following general description and the following detailed description are exemplary and explanatory only and are not restrictive. Provided herein are methods, systems, and apparatuses for improved logistics predictions. A computing device—or a network of devices—may be configured to provide a delivery prediction(s) related to a shipment(s) in-transit on a particular route(s). For example, a prediction engine may receive a first shipment identifier and first shipment metadata for a particular shipment (e.g., a parcel, package, letter, freight, etc.). The first shipment metadata may indicate a dispatch date/time, an expected delivery date/time, and/or a first route identifier. The first route identifier may identify a delivery route associated with a plurality of route hubs (e.g., warehouses, delivery stops, transit locations, etc.). The prediction engine may retrieve data related to a plurality of existing shipments associated with the plurality of route hubs (e.g., shipments using the same route—or a portion thereof—as the “first shipment”).

The prediction engine may use at least one survival model, such as a Kaplan-Meier survival model, to determine an on-time delivery prediction for each of the plurality of existing shipments at each of the plurality of route hubs. The prediction engine may also use the at least one survival model to determine a first on-time delivery prediction for the first shipment. For example, the prediction engine may determine the first on-time delivery prediction for the first shipment based on the dispatch date/time and/or the expected delivery date/time indicated by the first shipment metadata. Additionally, or in the alternative, the prediction engine may determine the first on-time delivery prediction for the first shipment based on a current location of the first shipment (e.g., one of the plurality of route hubs) and/or based on the on-time delivery prediction for each of the plurality of existing shipments at each of the plurality of route hubs. The first on-time delivery prediction may include a level of confidence associated with the expected delivery date/time (e.g., a 70% chance of on-time delivery with a 95% level of confidence). The prediction engine may cause the first shipment metadata to be modified based on the first on-time delivery prediction. For example, the prediction engine may cause the expected delivery date/time to be modified to indicate an updated delivery date/time (e.g., an earlier or a later delivery date/time). Additionally, or in the alternative, the prediction engine may cause the first route identifier to be modified to indicate a change (e.g., a new route, a skipped hub, a new hub, etc.).

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of the present description serve to explain the principles of the methods and systems described herein:

FIG. 1 shows an example system;

FIG. 2 shows a data table;

FIG. 3A shows an example graph;

FIG. 3B shows an example graph;

FIG. 4 shows an example system;

FIG. 5 shows a flowchart for an example method; and

FIG. 6 shows a flowchart for an example method.

### DETAILED DESCRIPTION

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another configuration includes from the one particular value and/or to the other particular value. Similarly, when values are expressed as approximations, by use of the antecedent “about,” it will be understood that the particular value forms another configuration. It will be further understood that the endpoints of each of the ranges are significant both in relation to the other endpoint, and independently of the other endpoint.

“Optional” or “optionally” means that the subsequently described event or circumstance may or may not occur, and that the description includes cases where said event or circumstance occurs and cases where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal configuration. “Such as” is not used in a restrictive sense, but for explanatory purposes.

It is understood that when combinations, subsets, interactions, groups, etc. of components are described that, while specific reference of each various individual and collective combinations and permutations of these may not be explicitly described, each is specifically contemplated and described herein. This applies to all parts of this application including, but not limited to, steps in described methods. Thus, if there are a variety of additional steps that may be performed it is understood that each of these additional steps may be performed with any specific configuration or combination of configurations of the described methods.

As will be appreciated by one skilled in the art, hardware, software, or a combination of software and hardware may be implemented. Furthermore, a computer program product on a computer-readable storage medium (e.g., non-transitory) having processor-executable instructions (e.g., computer software) embodied in the storage medium. Any suitable computer-readable storage medium may be utilized including hard disks, CD-ROMs, optical storage devices, magnetic storage devices, memresistors, Non-Volatile Random Access Memory (NVRAM), flash memory, or a combination thereof.

Throughout this application reference is made to block diagrams and flowcharts. It will be understood that each block of the block diagrams and flowcharts, and combinations of blocks in the block diagrams and flowcharts, respectively, may be implemented by processor-executable instructions. These processor-executable instructions may be loaded onto a general purpose computer, special purpose computer, or other programmable data processing apparatus to produce a machine, such that the processor-executable instructions which execute on the computer or other programmable data processing apparatus create a device for implementing the functions specified in the flowchart block or blocks.

These processor-executable instructions may also be stored in a computer-readable memory that may direct a computer or other programmable data processing apparatus to function in a particular manner, such that the processor-executable instructions stored in the computer-readable memory produce an article of manufacture including processor-executable instructions for implementing the function specified in the flowchart block or blocks. The processor-executable instructions may also be loaded onto a computer or other programmable data processing apparatus to cause a series of operational steps to be performed on the computer or other programmable apparatus to produce a computer-implemented process such that the processor-executable instructions that execute on the computer or other programmable apparatus provide steps for implementing the functions specified in the flowchart block or blocks.

Blocks of the block diagrams and flowcharts support combinations of devices for performing the specified functions, combinations of steps for performing the specified functions and program instruction means for performing the specified functions. It will also be understood that each block of the block diagrams and flowcharts, and combinations of blocks in the block diagrams and flowcharts, may be implemented by special purpose hardware-based computer systems that perform the specified functions or steps, or combinations of special purpose hardware and computer instructions.

Provided herein are methods and systems for improved logistics predictions. A computing device—or a network of devices—may be configured to provide a delivery prediction(s) related to a shipment(s) in-transit on a particular route(s). For example, a prediction engine associated with the computing device—or the network of devices—may receive a first shipment identifier and first shipment metadata for a particular shipment (e.g., a parcel, package, letter, freight, etc.). The first shipment metadata may indicate a dispatch date/time, an expected delivery date/time, and/or a first route identifier. The first route identifier may identify a delivery route associated with a plurality of route hubs (e.g., warehouses, delivery stops, transit locations, etc.). The prediction engine may retrieve data related to a plurality of existing shipments associated with the plurality of route hubs (e.g., shipments using the same route—or a portion thereof—as the “first shipment”).

The prediction engine may use at least one survival model, such as a Kaplan-Meier survival model, to determine an on-time delivery prediction for each of the plurality of existing shipments at each of the plurality of route hubs. For example, the prediction engine may receive a plurality of updates to the shipment metadata associated with the plurality of existing shipment identifiers. The plurality of updates may comprise, for example, at least one of: an indication of a delay, an indication of a loss, an indication of an arrival at a route hub of the plurality of route hubs, or an indication of a departure from a route hub of the plurality of route hubs. The plurality of updates may be received at a threshold interval. The threshold may relate to a quantity of time (e.g., every X seconds, minutes, hours, etc.) and/or an event (e.g., at each route hub, etc.). The threshold interval may comprise, for example, a static refresh interval (e.g., updated at a same frequency) and/or a dynamic refresh interval (e.g., updated with a changing frequency).

The plurality of existing shipments may be associated with a plurality of expected delivery dates/times (e.g., determined at time of shipment and/or during transit). The prediction engine may provide data indicative of the plurality of updates and the plurality of expected delivery dates/times for the existing shipments to the at least one survival model (e.g., as input data). The at least one survival model may determine a level of confidence for each of the plurality of expected delivery dates/times. For example, the level of confidence for a particular expected delivery date/time for a particular existing shipment may comprise a percentage or other value indicative of a prediction that the particular existing shipment will arrive at its corresponding delivery destination on or before the particular expected delivery date/time. Each level of confidence may differ at each of the plurality of route hubs (e.g., to indicate relative risk of a late delivery at each hub along the route).

The prediction engine may use the at least one survival model to determine a first on-time delivery prediction for the first shipment. For example, the prediction engine may determine the first on-time delivery prediction for the first shipment based on the dispatch date/time and/or the expected delivery date/time indicated by the first shipment metadata. Additionally, or in the alternative, the prediction engine may determine the first on-time delivery prediction for the first shipment based on a current location of the first shipment (e.g., one of the plurality of route hubs) and/or based on the on-time delivery prediction for each of the plurality of existing shipments at each of the plurality of route hubs. For example, the prediction engine may determine that at least one existing shipment of the plurality of existing shipments is delayed at a first route hub of the plurality of route hubs. The current location may comprise the first route hub, and the prediction engine may determine the first on-time delivery prediction for the first shipment based on the current location being the first route hub (e.g., at which the at least one existing shipment is delayed). The first on-time delivery prediction may include a level of confidence associated with the expected delivery date/time (e.g., a 70% chance of on-time delivery with a 95% level of confidence).

The prediction engine may cause the first shipment metadata to be modified. The prediction engine may cause the first shipment metadata to be modified based on the first on-time delivery prediction (e.g., indicating an earlier or later delivery as compared to the expected delivery date/time). The prediction engine may cause the expected delivery date/time to be modified to indicate an updated delivery date/time (e.g., an earlier or a later delivery date/time). The prediction engine may append the level of confidence associated with the expected delivery date/time for the first shipment to the first shipment metadata. The level of confidence may be accessible via a user interface associated with the computing device and/or the network of devices.

The prediction engine may associate the first shipment identifier with a second route identifier. The second route identifier may be associated with at least one route hub of the plurality of route hubs—but not every one of them. For example, the second route identifier may be associated with the first shipment identifier in order to cause the first shipment to be shipped along the second route, which may be associated with less delays or transit issues. The second route may be determined by the prediction engine based on the level of confidence determined for each of the plurality of route hubs (e.g., based on a relative risk of a late delivery at each hub along the route).

The prediction engine may modify a shipment priority associated with the first shipment identifier. For example, the first shipment identifier may initially (e.g., at time of departure or sometime prior to the modification) be associated with a first shipment priority indicative of a first level of service (e.g., delivery speed, delivery class, etc.). The shipment priority post-modification may be indicative of a second level of service (e.g., delivery speed, delivery class, etc.). The second level of service may comprise a higher/more efficient level of service as compared to the first level of service (e.g., express service vs. standard service, air service/airplane transit vs. ground service/truck transit, etc.).

The prediction engine may modify a shipping courier identifier associated with the first shipment identifier. For example, the first shipment identifier may initially (e.g., at time of departure or sometime prior to the modification) be associated with a first shipping courier (e.g., a postal carrier, a logistics/freight server, a parcel carrier, etc.). The shipping courier identifier post-modification may be indicative of a second shipping courier that differs from the first shipping courier.

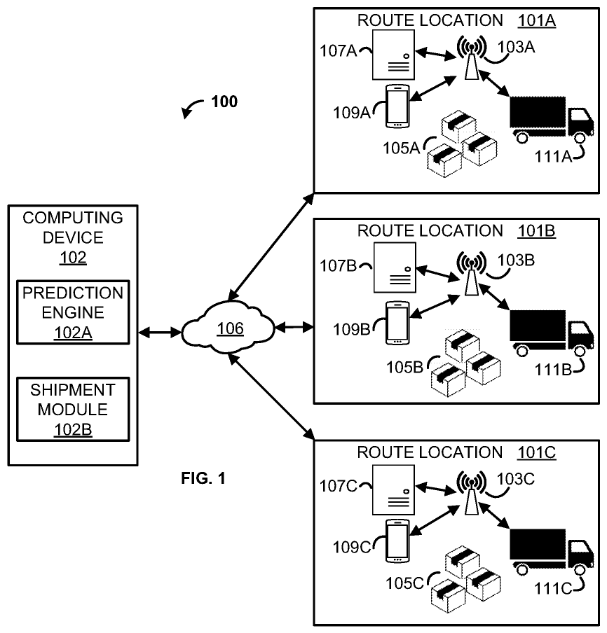

FIG. 1 shows a block diagram of an example system 100 for improved logistics predictions. The system 100 may comprise a computing device 102 having a prediction engine 102A and/or a shipment module 102B resident thereon. While FIG. 1 shows the computing device 102 as being a single computing device, it is to be understood that the functionality of the computing device 102, the prediction engine 102A, and/or a shipment module 102B may be performed by a network/plurality of computing devices/modules. As further described herein, the computing device 102 may process shipping data via one or more of the prediction engine 102A or the shipment module 102B.

The system 100 may comprise a plurality of route locations 101A, 101B, 101C. Each of the plurality of route locations 101A, 101B, 101C may be associated with a route identifier. Each of the plurality of route locations 101A, 101B, 101C may comprise a shipping depot, warehouse, loading dock, store, container, or any other suitable location. Each of the plurality of route locations 101A, 101B, 101C may comprise a comprise a network device 103A, 103B, 103C (e.g., a router, access point, etc.) in communication with one or more computing devices 107A, 107B, 107C (e.g., databases, network storage devices, etc.), one or more mobile devices 109A, 109B, 109C (e.g., scanners, smartphones, etc.), and/or one or more vehicles 111A, 111B, 111C (e.g., delivery trucks, courier vehicles, etc.) The network device 103A, 103B, 103C, the one or more computing devices 107A, 107B, 107C, the one or more mobile devices 109A, 109B, 109C, and/or the one or more vehicles 111A, 111B, 111C may be in communication with the computing device 102—as well as one another, in some examples—via a network 106. The network 106 may be an optical 106 fiber network, a coaxial cable network, a hybrid fiber-coaxial network, a wireless network, a satellite system, a direct broadcast system, an Ethernet network, a high-definition multimedia interface network, a Universal Serial Bus (USB) network, or any combination thereof. Data may be sent by or to any of the plurality of computing devices via a variety of transmission paths of the network 106, including wireless paths (e.g., satellite paths, Wi-Fi paths, cellular paths, etc.) and terrestrial paths (e.g., wired paths, a direct line, etc.).

Each of the plurality of route locations 101A, 101B, 101C may comprise or be associated with a plurality of shipments 105A, 105B, 105C, such as parcels, packages, letters, freight items, cargo items, a combination thereof, and/or the like. The plurality of shipments 105A, 105B, 105C may be transported/carried by the one or more vehicles 111A, 111B, 111C to/from each of the plurality of route locations 101A, 101B, 101C. As the plurality of shipments 105A, 105B, 105C are received at/dispatched from each of the plurality of route locations 101A, 101B, 101C, the one or more mobile devices 109A, 109B, 109C (e.g., scanners, smartphones, etc.) may be used to track each of the plurality of shipments 105A, 105B, 105C. For example, the one or more mobile devices 109A, 109B, 109C may scan barcodes/identifiers, take photographs, and/or detect a sensor for each of the plurality of shipments 105A, 105B, 105C. The one or more mobile devices 109A, 109B, 109C may send associated data (e.g., shipment identifiers and shipment metadata) to the one or more computing devices 107A, 107B, 107C via the network devices 103A, 103B, 103C. The associated data may be stored by the one or more computing devices 107A, 107B, 107C (e.g., in a database, data store, etc.). As further described herein, the computing device 102 may receive and/or retrieve the associated data from the one or more computing devices 107A, 107B, 107C and determine a delivery prediction for at least one of the plurality of shipments 105A, 105B, 105C.

While each of the plurality of route locations 101A, 101B, 101C are shown in FIG. 1 as having only one network device 103A, 103B, 103C, one computing device 107A, 107B, 107C, one mobile device 109A, 109B, 109C, and one vehicle 111A, 111B, 111C, it is to be understood that each of the plurality of route locations 101A, 101B, 101C may include more than one of each of the aforementioned devices. Further, it is to be understood that each of the plurality of route locations 101A, 101B, 101C may not include all of the aforementioned devices, although each is shown in FIG. 1 as including at least one of each.

As described herein, the computing device 102 may be configured to determine a delivery prediction for the plurality of shipments 105A, 105B, 105C. For example, the computing device may receive a first shipment identifier and first shipment metadata for the shipment 105A. The shipment 105A may comprise a parcel, a package, a letter, freight, cargo etc. at the route location 105A. The computing device 102 may receive the first shipment identifier and the first shipment metadata from the computing device 107A via the shipment module 102B. The first shipment metadata may comprise a dispatch date/time, an expected delivery date/time, and/or a first route identifier. The first route identifier may identify a delivery route associated with a route locations 101A, 101B, 101C.

The computing device 102 may determine a plurality of existing shipment identifiers for a plurality of existing shipments associated with the route locations 101A, 101B, 101C. The computing device 102 may determine the plurality of existing shipment identifiers based on the first route identifier. The plurality of existing shipments may be other shipments using the same route—or a portion thereof—as the shipment 105A, such as the other shipments of the plurality of shipments 105A, 105B, 105C at each of the plurality of route locations 101A, 101B, 101C. For example, the prediction engine 102A may retrieve/receive data related to the plurality of existing shipments via one or more of the mobile devices 109A, 109B, 109C (e.g., scanners, smartphones, etc.), one or more of the vehicles 111A, 111B, 111C (e.g., delivery trucks, courier vehicles, etc.), and/or one or more of the computing devices 107A, 107B, 107C.

The computing device 102 may determine an on-time delivery prediction for each of the plurality of existing shipments at each of the route locations 101A, 101B, 101C. For example, the prediction engine 102A may use at least one survival model, such as a Kaplan-Meier survival model, and shipment metadata associated with the plurality of existing shipments to determine the on-time delivery prediction for each of the plurality of existing shipments. The prediction engine 102A may receive a plurality of updates to the shipment metadata associated with the plurality of existing shipment identifiers. The plurality of updates may comprise, for example, at least one of: an indication of a delay, an indication of a loss, an indication of an arrival at a route hub of the route locations 101A, 101B, 101C, or an indication of a departure from a route hub of the route locations 101A, 101B, 101C. The plurality of updates may be received at a threshold interval. The threshold may relate to a quantity of time (e.g., every X seconds, minutes, hours, etc.) and/or an event (e.g., at each route hub, etc.). The threshold interval may comprise, for example, a static refresh interval (e.g., updated at a same frequency) and/or a dynamic refresh interval (e.g., updated with a changing frequency).

The plurality of existing shipments may be associated with a plurality of expected delivery dates/times (e.g., determined at time of shipment and/or during transit). The prediction engine 102A may provide data indicative of the plurality of updates and the plurality of expected delivery dates/times for the existing shipments to the at least one survival model (e.g., as input data). The at least one survival model may determine a level of confidence for each of the plurality of expected delivery dates/times. For example, the level of confidence for a particular expected delivery date/time for a particular existing shipment may comprise a percentage or other value indicative of a prediction that the particular existing shipment will arrive at its corresponding delivery destination on or before the particular expected delivery date/time. Each level of confidence may differ at each of the route locations 101A, 101B, 101C (e.g., the plurality of route locations 101A, 101B, 101C) to indicate relative risk of a late delivery at each hub along the route.

The computing device 102 may determine a first on-time delivery prediction for the shipment 105A. The first on-time delivery prediction may comprise a level of confidence associated with the expected delivery date/time (e.g., a 70% chance of on-time delivery with a 95% level of confidence). The level of confidence associated with the expected delivery date/time may comprise a percentage or other value indicative of a prediction that the shipment 105A will arrive at its corresponding delivery destination on or before the expected delivery date/time. The prediction engine 102A may use the at least one survival model to determine the first on-time delivery prediction for the shipment 105A. For example, the prediction engine 102A may determine the first on-time delivery prediction for the shipment 105A based on the dispatch date/time and/or the expected delivery date/time indicated by the first shipment metadata. Additionally, or in the alternative, the prediction engine 102A may determine the first on-time delivery prediction for the shipment 105A based on a current location of the shipment 105A (e.g., one of the plurality of route locations 101A, 101B, 101C) and/or based on the on-time delivery prediction for each of the plurality of existing shipments at each of the plurality of route locations 101A, 101B, 101C. For example, the prediction engine 102A may determine that at least one existing shipment of the plurality of existing shipments is delayed at the route location 101A. The current location of the shipment 105A may comprise the route location 101A, and the prediction engine 102A may determine the first on-time delivery prediction for the shipment 105A based on the current location being the route location 101A.

In some examples, the computing device 102 may cause the first shipment metadata to be modified. For example, the prediction engine 102A may cause the first shipment metadata to be modified based on the first on-time delivery prediction (e.g., indicating an earlier or later delivery as compared to the expected delivery date/time). The prediction engine 102A may cause the expected delivery date/time to be modified to indicate an updated delivery date/time (e.g., an earlier or a later delivery date/time). The prediction engine 102A may append the level of confidence associated with the expected delivery date/time for the shipment 105A to the first shipment metadata. The level of confidence associated with the expected delivery date/time for the shipment 105A may be accessible via a user interface associated with the computing device and/or any of the entities/devices at any of the plurality of route locations 101A, 101B, 101C.

In some examples, the prediction engine 102A may associate the first shipment identifier with a second route identifier. The second route identifier may be associated with at least one route hub of the route locations 101A, 101B, 101C—but not every one of them. For example, the second route identifier may be associated with the first shipment identifier in order to cause the shipment 105A to be shipped along the second route, which may be associated with less delays or transit issues. The second route may be determined by the prediction engine 102A based on the level of confidence determined for each of the route locations 101A, 101B, 101C (e.g., based on a relative risk of a late delivery at each hub along the route).

In some examples, the prediction engine 102A may modify a shipment priority associated with the first shipment identifier and/or the first shipment metadata. For example, the first shipment identifier and/or the first shipment metadata may initially (e.g., at time of departure or sometime prior to the modification) be associated with a first shipment priority indicative of a first level of service (e.g., delivery speed, delivery class, etc.). The shipment priority post-modification may be indicative of a second level of service (e.g., delivery speed, delivery class, etc.). The second level of service may comprise a higher/more efficient level of service as compared to the first level of service (e.g., express service vs. standard service, air service/airplane transit vs. ground service/truck transit, etc.).

In some examples, the prediction engine 102A may modify a shipping courier identifier associated with the first shipment identifier and/or the first shipment metadata. For example, the first shipment identifier and/or the first shipment metadata may initially (e.g., at time of departure or sometime prior to the modification) be associated with a first shipping courier (e.g., a postal carrier, a logistics/freight server, a parcel carrier, etc.). The shipping courier identifier post-modification may be indicative of a second shipping courier that differs from the first shipping courier.

The computing device 102 may receive second shipment metadata for the shipment 105A. The computing device 102 may receive the second shipment metadata from the computing device 107B via the shipment module 102B. The second shipment metadata may comprise a second location of the shipment 105A, such as the route location 101B. The computing device 102 may determine a second on-time delivery prediction for the shipment 105A. The second on-time delivery prediction may comprise a second level of confidence associated with the expected delivery date/time (e.g., a 70% chance of on-time delivery with a 95% level of confidence). The second level of confidence associated with the expected delivery date/time may comprise a percentage or other value indicative of a prediction that the shipment 105A will arrive at its corresponding delivery destination on or before the expected delivery date/time. The prediction engine 102A may use the at least one survival model to determine the second on-time delivery prediction for the shipment 105A. For example, the prediction engine 102A may determine the second on-time delivery prediction based on an output from the survival model using the first shipment metadata and the second shipment metadata as input for the survival model. For example, the first shipment metadata may comprise a date and/or time that the shipment 105A arrived at the route location 101A, and the second shipment metadata may comprise a date and/or time that the shipment 105A arrived at the route location 101B. The prediction engine 102A may determine the second on-time delivery prediction based on the date and/or time that the shipment 105A arrived at the route location 101A and the date and/or time that the shipment 105A arrived at the route location 101B. Other examples are possible as well.

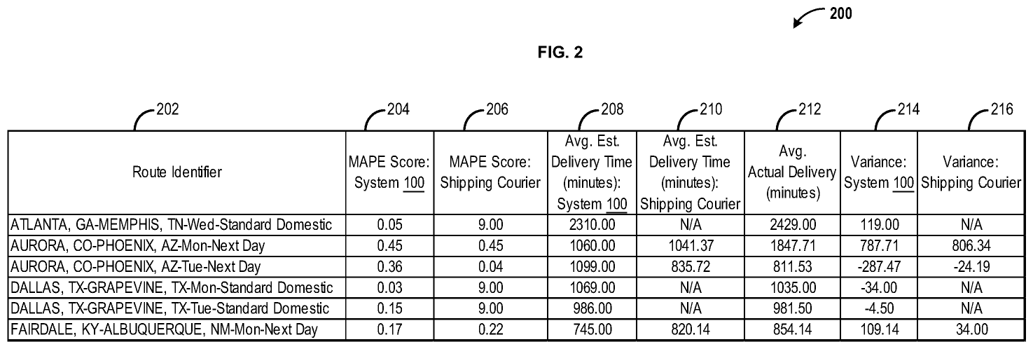

The logistics predictions provided by the system 100 represent an improvement to existing systems for logistics predictions. For example, FIG. 2 shows a data table 200 comparing the logistics predictions determined by the system 100 to those determined for a large shipping courier using the existing systems. Column 202 of the table 200 lists a plurality route identifiers. Each route identifier may identify—or be indicative of—a delivery route associated with a plurality of route hubs. The plurality of route hubs may comprise, for example, a route location such as one or more of the plurality of route locations 101A, 101B, 101C (e.g., warehouses, delivery stops, transit locations, etc.). Each route identifier may identify—or be indicative of—a first route hub of the plurality of route hubs corresponding to a dispatch location. Each route identifier may identify—or be indicative of—a second hub of the plurality of route hubs corresponding to a delivery destination. Each route identifier may identify—or be indicative of—a shipment day or time (e.g., a dispatch date/time as described herein). Each route identifier may identify—or be indicative of—a shipment priority indicative of a level of service (e.g., delivery speed, delivery class, etc.).

For example, as shown in FIG. 2, the first route identifier in the table 200 comprises “ATLANTA, Ga.—MEMPHIS, Tenn.—WED—STANDARD DOMESTIC.” The first route hub/dispatch location for the first route identifier in the table 200 may be “ATLANTA, Ga.” The second route hub/delivery destination for the first route identifier in the table 200 may be “MEMPHIS, Tenn.” The shipment day for the first route identifier in the table 200 may be “Wednesday.” The shipment priority indicative of the level of service for the first route identifier in the table 200 may be “Standard Domestic” service.

Each route identifier may identify—or be indicative of—an expected delivery date/time. For example, the shipment day or time for a route identifier may comprise “Monday,” and the shipment priority may be indicative of a level of service of “Next Day.” Accordingly, in such an example, the shipment priority would be indicative of an expected delivery date/time of “Tuesday.”

As noted above, the table 200 may compare the logistics predictions determined by the system 100 to those determined for a large shipping courier (referred to as “Shipping Courier” in the table 200). The comparison may be based on a Mean Absolute Percentage Error (MAPE) score for each route identifier listed in column 202. The table 200 shows a MAPE score for each route identifier using the logistics predictions provided by the system 100 (column 204) as well as using the existing systems used by the large shipping courier (column 206).

The MAPE score for a route identifier may be determined by dividing a result of an actual delivery time (in minutes) minus an expected delivery time (in minutes) by the actual delivery time. For example, for the first route identifier in the table 200, the MAPE score for the logistics predictions provided by the system 100 may be 0.05 (column 204). This MAPE score may be determined by dividing the actual delivery time indicated in column 212 minus the expected delivery time determined by the system 100 indicated in column 208 by the actual delivery time indicated in column 212 (e.g., 0.05=(2429−2310)/2429).

The column 214 may indicate a variance between the expected delivery time determined by the system 100 indicated in column 208 and the actual delivery time indicated in column 212. The column 216 may indicate a variance between an expected delivery time determined by the large shipping courier indicated in column 210 and the actual delivery time indicated in column 212.

The logistics predictions provided by the system 100 may use higher resolution data (e.g., more granular) as compared to the large shipping courier using the existing systems. For example, the existing systems do not include an average estimated delivery time for some levels of service, such as the “Standard Domestic” level of service indicated by the first route identifier in the table 200, and, as a result, the existing systems cannot determine a corresponding MAPE score. For example, the MAPE score for the first route identifier in the table 200 for the large shipping courier may be 9.00 (column 206), because the existing systems do not include an average estimated delivery time for the “Standard Domestic” level of service indicated by the first route identifier in the table 200. For the same reason, the column 216 may not indicate a variance between the expected delivery time determined by the large shipping courier indicated in column 210 and the actual delivery time indicated in column 212.

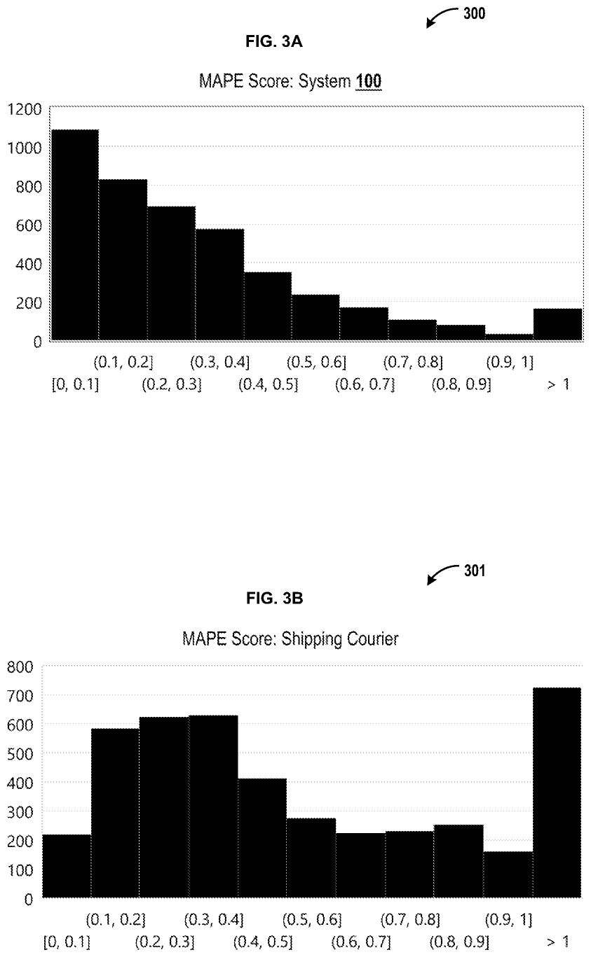

Turning now to FIGS. 3A and 3B, example graphs 300 and 301 are shown. The graphs 300 and 301 are based on shipping data and logistics predictions determined by the system 100 and the large shipping courier discussed above. The horizontal axis in the graphs 300 and 301 indicate ranges of MAPE scores for each bar shown in each graph, and the vertical axis in the graphs 300 and 301 indicates a number of shipments. For example, as shown in the graph 300, the system 100 determined logistics predictions for approximately 1,100 packages with a MAPE score ranging between 0 and 0.1, while the graph 301 indicates the large shipping courier determined logistics predictions for just over 200 packages with a MAPE score ranging between 0 and 0.1. As can be seen in the graphs 300 and 301, the logistics predictions determined by the system 100 using the methods described herein are more accurate than those determined by the large shipping courier using the existing systems.

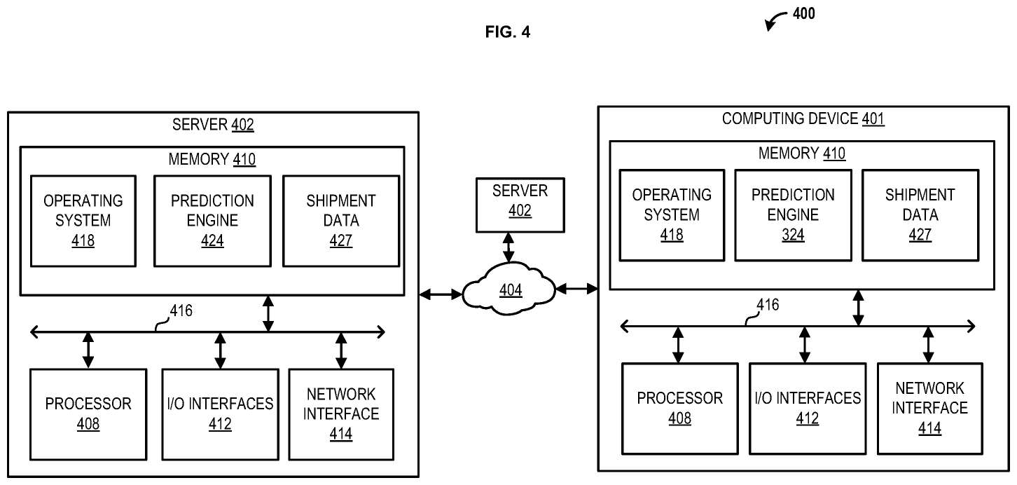

As discussed herein, the present methods and systems may be computer-implemented. FIG. 4 shows a block diagram depicting a system/environment 400 comprising non-limiting examples of a computing device 401 and a server 402 connected through a network 404. Either of the computing device 401 or the server 402 may be a computing device such as the computing device 102 and/or any of the entities/devices at any of the plurality of route locations 101A, 101B, 101C shown in FIG. 1. In an aspect, some or all steps of any described method may be performed on a computing device as described herein. The computing device 401 and/or the server 402 may comprise one or multiple computers and/or modules configured to store and/or execute one or more of a prediction engine 424, shipment data 427, and/or the like. Multiple servers 402 may communicate with the computing device 401 via the network 404.

The computing device 401 and the server 402 may be a digital computer that, in terms of hardware architecture, generally includes a processor 408, system memory 410, input/output (I/O) interfaces 412, and network interfaces 414. These components (408, 410, 412, and 414) may be communicatively coupled via a local interface 416. The local interface 416 may be, for example, but not limited to, one or more buses or other wired or wireless connections, as is known in the art. The local interface 416 may have additional elements, which are omitted for simplicity, such as controllers, buffers (caches), drivers, repeaters, and receivers, to enable communications. Further, the local interface may include address, control, and/or data connections to enable appropriate communications among the aforementioned components.

The processor 408 may be a hardware device for executing software, particularly that stored in system memory 410. The processor 408 may be any custom made or commercially available processor, a central processing unit (CPU), an auxiliary processor among several processors associated with the computing device 401 and the server 402, a semiconductor-based microprocessor (in the form of a microchip or chip set), or generally any device for executing software instructions. When the computing device 401 and/or the server 402 is in operation, the processor 408 may be configured to execute software stored within the system memory 410, to communicate data to and from the system memory 410, and to generally control operations of the computing device 401 and the server 402 pursuant to the software.

The I/O interfaces 412 may be used to receive user input from, and/or for providing system output to, one or more devices or components. User input may be provided via, for example, a keyboard and/or a mouse. System output may be provided via a display device and a printer (not shown). I/O interfaces 412 may include, for example, a serial port, a parallel port, a Small Computer System Interface (SCSI), an infrared (IR) interface, a radio frequency (RF) interface, and/or a universal serial bus (USB) interface.

The network interface 414 may be used to transmit and receive from the computing device 401 and/or the server 402 on the network 404. The network interface 414 may include, for example, a 10BaseT Ethernet Adaptor, a 10BaseT Ethernet Adaptor, a LAN PHY Ethernet Adaptor, a Token Ring Adaptor, a wireless network adapter (e.g., WiFi, cellular, satellite), or any other suitable network interface device. The network interface 414 may include address, control, and/or data connections to enable appropriate communications on the network 404.

The system memory 410 may include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the system memory 410 may incorporate electronic, magnetic, optical, and/or other types of storage media. Note that the system memory 410 may have a distributed architecture, where various components are situated remote from one another, but may be accessed by the processor 408.

The software in system memory 410 may include one or more software programs, each of which comprises an ordered listing of executable instructions for implementing logical functions. In the example of FIG. 4, the software in the system memory 410 of the computing device 401 may comprise the prediction engine 424, the shipment data 427, and a suitable operating system (0/S) 418. In the example of FIG. 4, the software in the system memory 410 of the server 402 may comprise the prediction engine 424, the shipment data 427, and a suitable operating system (O/S) 418. The operating system 418 essentially controls the execution of other computer programs and provides scheduling, input-output control, file and data management, memory management, and communication control and related services.

For purposes of illustration, application programs and other executable program components such as the operating system 418 are shown herein as discrete blocks, although it is recognized that such programs and components may reside at various times in different storage components of the computing device 401 and/or the server 402. An implementation of the methods 500 and 600 may be stored on or transmitted across some form of computer readable media. Any of the disclosed methods may be performed by computer readable instructions embodied on computer readable media. Computer readable media may be any available media that may be accessed by a computer. By way of example and not meant to be limiting, computer readable media may comprise “computer storage media” and “communications media.” “Computer storage media” may comprise volatile and non-volatile, removable and non-removable media implemented in any methods or technology for storage of information such as computer readable instructions, data structures, program modules, or other data. Exemplary computer storage media may comprise RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by a computer.

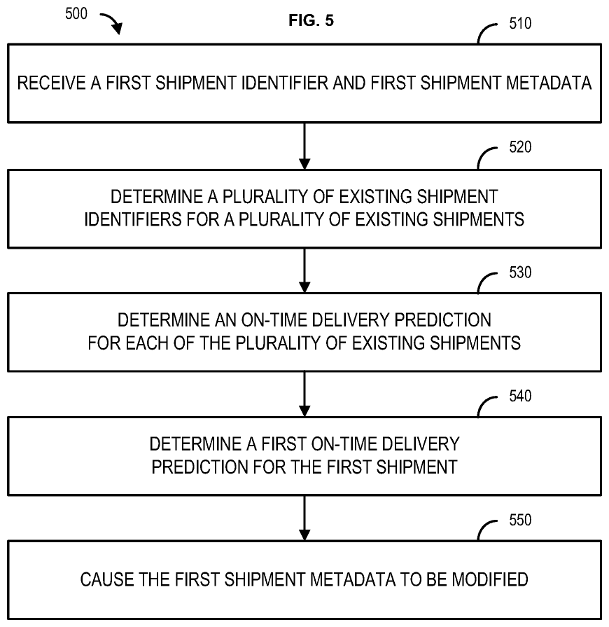

FIG. 5 shows a flowchart of an example method 500 for improved logistics predictions. The method 500 may be performed in whole or in part by a single computing device, a plurality of computing devices, and the like. For example, the steps of the method 500 may be performed by any of the computing devices/entities shown in the plurality of route locations 101A, 101B, 101C and/or the computing device 102 shown in FIG. 1. Some steps of the method 500 may be performed by a first computing device, while other steps of the method 500 may be performed by another computing device(s).

A computing device, such as the computing device 102, may be configured to determine a delivery prediction for a first shipment and a plurality of existing shipments, such as any of the plurality of shipments 105A, 105B, 105C. At step 510, the computing device may receive a first shipment identifier and first shipment metadata for the first shipment. The first shipment may comprise a parcel, a package, a letter, freight, cargo etc. at the route location 105A. The computing device may receive the first shipment identifier and the first shipment metadata from the computing device 107A via the shipment module 102B. The first shipment metadata may comprise a dispatch date/time, an expected delivery date/time, and/or a first route identifier. The first route identifier may identify a delivery route associated with a plurality of route hubs. The plurality of route hubs may comprise one or more of the plurality of route locations 101A, 101B, 101C (e.g., warehouses, delivery stops, transit locations, etc.).

At step 520, the computing device may determine a plurality of existing shipment identifiers for a plurality of existing shipments associated with the plurality of route hubs. The computing device may determine the plurality of existing shipment identifiers for the plurality of existing shipments based on the first route identifier. The plurality of existing shipments may be other shipments using the same route—or a portion thereof—as the first shipment, such as the other shipments of the plurality of shipments 105A, 105B, 105C at each of the plurality of route locations 101A, 101B, 101C. For example, the prediction engine 102A may retrieve/receive data related to the plurality of existing shipments via one or more of the mobile devices 109A, 109B, 109C (e.g., scanners, smartphones, etc.), one or more of the vehicles 111A, 111B, 111C (e.g., delivery trucks, courier vehicles, etc.), and/or one or more of the computing devices 107A, 107B, 107C.

At step 530, the computing device may determine an on-time delivery prediction for each of the plurality of existing shipments at each of the plurality of route hubs. For example, the prediction engine 102A may use at least one survival model, such as a Kaplan-Meier survival model, and shipment metadata associated with the plurality of existing shipments to determine the on-time delivery prediction for each of the plurality of existing shipments. The prediction engine 102A may receive a plurality of updates to the shipment metadata associated with the plurality of existing shipment identifiers. The plurality of updates may comprise, for example, at least one of: an indication of a delay, an indication of a loss, an indication of an arrival at a route hub of the plurality of route hubs, or an indication of a departure from a route hub of the plurality of route hubs. The plurality of updates may be received at a threshold interval. The threshold may relate to a quantity of time (e.g., every X seconds, minutes, hours, etc.) and/or an event (e.g., at each route hub, etc.). The threshold interval may comprise, for example, a static refresh interval (e.g., updated at a same frequency) and/or a dynamic refresh interval (e.g., updated with a changing frequency).

The plurality of existing shipments may be associated with a plurality of expected delivery dates/times (e.g., determined at time of shipment and/or during transit). The prediction engine 102A may provide data indicative of the plurality of updates and the plurality of expected delivery dates/times for the existing shipments to the at least one survival model (e.g., as input data). The at least one survival model may determine a level of confidence for each of the plurality of expected delivery dates/times. For example, the level of confidence for a particular expected delivery date/time for a particular existing shipment may comprise a percentage or other value indicative of a prediction that the particular existing shipment will arrive at its corresponding delivery destination on or before the particular expected delivery date/time. Each level of confidence may differ at each of the plurality of route hubs (e.g., the plurality of route locations 101A, 101B, 101C) to indicate relative risk of a late delivery at each hub along the route.

At step 540, the computing device may determine a first on-time delivery prediction for the first shipment. The first on-time delivery prediction may comprise a level of confidence associated with the expected delivery date/time (e.g., a 70% chance of on-time delivery with a 95% level of confidence). The level of confidence associated with the expected delivery date/time may comprise a percentage or other value indicative of a prediction that the first shipment will arrive at its corresponding delivery destination on or before the expected delivery date/time. The prediction engine 102A may use the at least one survival model to determine the first on-time delivery prediction for the first shipment. For example, the prediction engine 102A may determine the first on-time delivery prediction for the first shipment based on the dispatch date/time and/or the expected delivery date/time indicated by the first shipment metadata. Additionally, or in the alternative, the prediction engine 102A may determine the first on-time delivery prediction for the first shipment based on a current location of the first shipment (e.g., one of the plurality of route locations 101A, 101B, 101C) and/or based on the on-time delivery prediction for each of the plurality of existing shipments at each of the plurality of route locations 101A, 101B, 101C. For example, the prediction engine 102A may determine that at least one existing shipment of the plurality of existing shipments is delayed at a first route hub of the plurality of route hubs (e.g., the route location 101A). The current location of the first shipment may comprise the first route hub, and the prediction engine 102A may determine the first on-time delivery prediction for the first shipment based on the current location being the first route hub (e.g., at which the at least one existing shipment is delayed).

At step 550, the computing device may cause the first shipment metadata to be modified. For example, the prediction engine 102A may cause the first shipment metadata to be modified based on the first on-time delivery prediction (e.g., indicating an earlier or later delivery as compared to the expected delivery date/time). The prediction engine 102A may cause the expected delivery date/time to be modified to indicate an updated delivery date/time (e.g., an earlier or a later delivery date/time). The prediction engine 102A may append the level of confidence associated with the expected delivery date/time for the first shipment to the first shipment metadata. The level of confidence associated with the expected delivery date/time for the first shipment may be accessible via a user interface associated with the computing device and/or any of the entities/devices at any of the plurality of route locations 101A, 101B, 101C.

The prediction engine 102A may associate the first shipment identifier with a second route identifier. The second route identifier may be associated with at least one route hub of the plurality of route hubs—but not every one of them. For example, the second route identifier may be associated with the first shipment identifier in order to cause the first shipment to be shipped along the second route, which may be associated with less delays or transit issues. The second route may be determined by the prediction engine 102A based on the level of confidence determined for each of the plurality of route hubs (e.g., based on a relative risk of a late delivery at each hub along the route).

The prediction engine 102A may modify a shipment priority associated with the first shipment identifier and/or the first shipment metadata. For example, the first shipment identifier and/or the first shipment metadata may initially (e.g., at time of departure or sometime prior to the modification) be associated with a first shipment priority indicative of a first level of service (e.g., delivery speed, delivery class, etc.). The shipment priority post-modification may be indicative of a second level of service (e.g., delivery speed, delivery class, etc.). The second level of service may comprise a higher/more efficient level of service as compared to the first level of service (e.g., express service vs. standard service, air service/airplane transit vs. ground service/truck transit, etc.).

The prediction engine 102A may modify a shipping courier identifier associated with the first shipment identifier and/or the first shipment metadata. For example, the first shipment identifier and/or the first shipment metadata may initially (e.g., at time of departure or sometime prior to the modification) be associated with a first shipping courier (e.g., a postal carrier, a logistics/freight server, a parcel carrier, etc.). The shipping courier identifier post-modification may be indicative of a second shipping courier that differs from the first shipping courier.

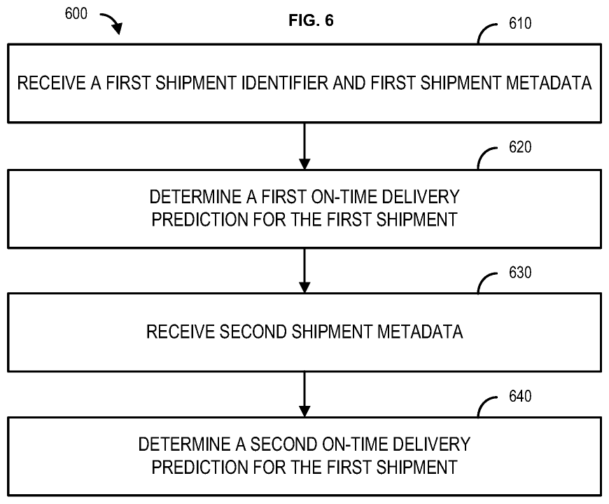

FIG. 6 shows a flowchart of an example method 600 for improved logistics predictions. The method 600 may be performed in whole or in part by a single computing device, a plurality of computing devices, and the like. For example, the steps of the method 600 may be performed by any of the computing devices/entities shown in the plurality of route locations 101A, 101B, 101C and/or the computing device 102 shown in FIG. 1. Some steps of the method 600 may be performed by a first computing device, while other steps of the method 600 may be performed by another computing device(s).

A computing device, such as the computing device 102, may be configured to determine a delivery prediction for a first shipment and a plurality of existing shipments, such as any of the plurality of shipments 105A, 105B, 105C. At step 610, the computing device may receive a first shipment identifier and first shipment metadata for the first shipment. The first shipment may comprise a parcel, a package, a letter, freight, cargo etc. at the route location 105A. The computing device may receive the first shipment identifier and the first shipment metadata from the computing device 107A via the shipment module 102B. The first shipment metadata may comprise a dispatch date/time, an expected delivery date/time, and/or a first route identifier. The first route identifier may identify a delivery route associated with a plurality of route hubs. The plurality of route hubs may comprise one or more of the plurality of route locations 101A, 101B, 101C (e.g., warehouses, delivery stops, transit locations, etc.).

The computing device may determine a plurality of existing shipment identifiers for a plurality of existing shipments associated with the plurality of route hubs. The computing device may determine the plurality of existing shipment identifiers for the plurality of existing shipments based on the first route identifier. The plurality of existing shipments may be other shipments using the same route—or a portion thereof—as the first shipment, such as the other shipments of the plurality of shipments 105A, 105B, 105C at each of the plurality of route locations 101A, 101B, 101C. For example, the prediction engine 102A may retrieve/receive data related to the plurality of existing shipments via one or more of the mobile devices 109A, 109B, 109C (e.g., scanners, smartphones, etc.), one or more of the vehicles 111A, 111B, 111C (e.g., delivery trucks, courier vehicles, etc.), and/or one or more of the computing devices 107A, 107B, 107C.

The computing device may determine an on-time delivery prediction for each of the plurality of existing shipments at each of the plurality of route hubs. For example, the prediction engine 102A may use at least one survival model, such as a Kaplan-Meier survival model, and shipment metadata associated with the plurality of existing shipments to determine the on-time delivery prediction for each of the plurality of existing shipments. The prediction engine 102A may receive a plurality of updates to the shipment metadata associated with the plurality of existing shipment identifiers. The plurality of updates may comprise, for example, at least one of: an indication of a delay, an indication of a loss, an indication of an arrival at a route hub of the plurality of route hubs, or an indication of a departure from a route hub of the plurality of route hubs. The plurality of updates may be received at a threshold interval. The threshold may relate to a quantity of time (e.g., every X seconds, minutes, hours, etc.) and/or an event (e.g., at each route hub, etc.). The threshold interval may comprise, for example, a static refresh interval (e.g., updated at a same frequency) and/or a dynamic refresh interval (e.g., updated with a changing frequency).

The plurality of existing shipments may be associated with a plurality of expected delivery dates/times (e.g., determined at time of shipment and/or during transit). The prediction engine 102A may provide data indicative of the plurality of updates and the plurality of expected delivery dates/times for the existing shipments to the at least one survival model (e.g., as input data). The at least one survival model may determine a level of confidence for each of the plurality of expected delivery dates/times. For example, the level of confidence for a particular expected delivery date/time for a particular existing shipment may comprise a percentage or other value indicative of a prediction that the particular existing shipment will arrive at its corresponding delivery destination on or before the particular expected delivery date/time. Each level of confidence may differ at each of the plurality of route hubs (e.g., the plurality of route locations 101A, 101B, 101C) to indicate relative risk of a late delivery at each hub along the route.

At step 620, the computing device may determine a first on-time delivery prediction for the first shipment. The first on-time delivery prediction may comprise a first level of confidence associated with the expected delivery date/time (e.g., a 70% chance of on-time delivery with a 95% level of confidence). The first level of confidence associated with the expected delivery date/time may comprise a percentage or other value indicative of a prediction that the first shipment will arrive at its corresponding delivery destination on or before the expected delivery date/time. The prediction engine 102A may use the at least one survival model to determine the first on-time delivery prediction for the first shipment. For example, the prediction engine 102A may determine the first on-time delivery prediction for the first shipment based on the dispatch date/time and/or the expected delivery date/time indicated by the first shipment metadata. Additionally, or in the alternative, the prediction engine 102A may determine the first on-time delivery prediction for the first shipment based on a first location of the first shipment (e.g., one of the plurality of route locations 101A, 101B, 101C) and/or based on the on-time delivery prediction for each of the plurality of existing shipments at each of the plurality of route locations 101A, 101B, 101C. The first location of the first shipment may comprise the first route hub, and the prediction engine 102A may determine the first on-time delivery prediction for the first shipment based on the first location.

At step 630, the computing device may receive second shipment metadata for the first shipment. The computing device may receive the second shipment metadata from the computing device 107B via the shipment module 102B. The second shipment metadata may comprise a second location of the first shipment (e.g., one of the plurality of route locations 101A, 101B, 101C), such as a second route hub of the plurality of route hubs (e.g., the route location 101B). At step 650, the computing device may determine a second on-time delivery prediction for the first shipment. The second on-time delivery prediction may comprise a second level of confidence associated with the expected delivery date/time (e.g., a 70% chance of on-time delivery with a 95% level of confidence). The second level of confidence associated with the expected delivery date/time may comprise a percentage or other value indicative of a prediction that the first shipment will arrive at its corresponding delivery destination on or before the expected delivery date/time. The prediction engine 102A may use the at least one survival model to determine the second on-time delivery prediction for the first shipment. For example, the prediction engine 102A may determine the second on-time delivery prediction based on an output from the survival model using the first shipment metadata and the second shipment metadata as input for the survival model. For example, the first shipment metadata may comprise a date and/or time that the first shipment arrived at the first location, and the second shipment metadata may comprise a date and/or time that the first shipment arrived at the second location. The prediction engine 102A may determine the second on-time delivery prediction based on the date and/or time that the first shipment arrived at the first location and the date and/or time that the first shipment arrived at the second location. Other examples are possible as well.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method comprising:
receiving, by a computing device, a first shipment identifier and first shipment metadata, wherein the first shipment metadata comprises a dispatch date/time, an expected delivery date/time, and a first route identifier associated with a plurality of route hubs;
determining, based on the first route identifier, a plurality of existing shipment identifiers for a plurality of existing shipments associated with the plurality of route hubs;
determining, by at least one survival model, based on shipment metadata associated with the plurality of existing shipment identifiers, an on-time delivery prediction for each of the plurality of existing shipments at each of the plurality of route hubs; and
determining, by the at least one survival model, based on:
the dispatch date/time,
the expected delivery date/time,
a current location of the first shipment, wherein the current location comprises one of the plurality of route hubs, and
the on-time delivery prediction for each of the plurality of existing shipments at each of the plurality of route hubs,
a first on-time delivery prediction for the first shipment, wherein the first on-time delivery prediction comprises a level of confidence associated with the expected delivery date/time.

2. The method of claim 1, wherein determining the on-time delivery prediction for each of the plurality of existing shipments at each of the plurality of route hubs comprises:
receiving, at a threshold interval, a plurality of updates to the shipment metadata associated with the plurality of existing shipment identifiers; and
determining, for each of the plurality of existing shipments at each of the plurality of route hubs, based on the plurality of updates, and based on a plurality of expected delivery dates/times associated with the plurality of existing shipments, a level of confidence for each of the plurality of expected delivery dates/times.

3. The method of claim 2, wherein the threshold interval comprises at least one of a static refresh interval or a dynamic refresh interval.

4. The method of claim 2, wherein the plurality of updates comprises at least one of: an indication of a delay, an indication of a loss, an indication of an arrival at a route hub of the plurality of route hubs, or an indication of a departure from a route hub of the plurality of route hubs.

5. The method of claim 2, wherein the level of confidence for each of the plurality of expected delivery dates/times differs at each of the plurality of route hubs.

6. The method of claim 2, further comprising:
determining, based on the plurality of updates, that at least one of the plurality of existing shipments is delayed at a first route hub of the plurality of route hubs, wherein the current location comprises the first route hub; and
determining, based on the at least one existing shipment being delayed, and based on the at least one survival model, the on-time delivery prediction for the at least one existing shipment.

7. The method of claim 1, further comprising at least one of:
appending, to the first shipment metadata, the level of confidence associated with the expected delivery date/time;
associating the first shipment identifier with a second route identifier, wherein the second route identifier is associated with at least one route hub of the plurality of route hubs;
modifying a shipment priority associated with the first shipment identifier;
modifying a shipping courier identifier associated with the first shipment identifier; or
modifying the expected delivery time/date.

8. The method of claim 1, wherein the at least one survival model comprises a Kaplan-Meier survival algorithm.

9. An apparatus comprising:
one or more processors; and
memory storing processor-executable instructions that, when executed by the one or more processors, cause the apparatus to:
receive a first shipment identifier and first shipment metadata, wherein the first shipment metadata comprises a dispatch date/time, an expected delivery date/time, and a first route identifier associated with a plurality of route hubs;
determine, based on the first route identifier, a plurality of existing shipment identifiers for a plurality of existing shipments associated with the plurality of route hubs;
determine, by at least one survival model, based on shipment metadata associated with the plurality of existing shipment identifiers, an on-time delivery prediction for each of the plurality of existing shipments at each of the plurality of route hubs; and
determine, by the at least one survival model, based on:
the dispatch date/time,
the expected delivery date/time,
a current location of the first shipment, wherein the current location comprises one of the plurality of route hubs, and
the on-time delivery prediction for each of the plurality of existing shipments at each of the plurality of route hubs,
a first on-time delivery prediction for the first shipment, wherein the first on-time delivery prediction comprises a level of confidence associated with the expected delivery date/time.

10. The apparatus of claim 9, wherein the processor-executable instructions that cause the apparatus to determine the on-time delivery prediction for each of the plurality of existing shipments at each of the plurality of route hubs further cause the apparatus to:
receiving, at a threshold interval, a plurality of updates to the shipment metadata associated with the plurality of existing shipment identifiers; and
determining, for each of the plurality of existing shipments at each of the plurality of route hubs, based on the plurality of updates, and based on a plurality of expected delivery dates/times associated with the plurality of existing shipments, a level of confidence for each of the plurality of expected delivery dates/times.

11. The apparatus of claim 9, wherein the threshold interval comprises at least one of a static refresh interval or a dynamic refresh interval.

12. The apparatus of claim 10, wherein the plurality of updates comprises at least one of:
an indication of a delay, an indication of a loss, an indication of an arrival at a route hub of the plurality of route hubs, or an indication of a departure from a route hub of the plurality of route hubs.

13. The apparatus of claim 10, wherein the level of confidence for each of the plurality of expected delivery dates/times differs at each of the plurality of route hubs.

14. The apparatus of claim 10, wherein the processor-executable instructions further cause the apparatus to:
determine, based on the plurality of updates, that at least one of the plurality of existing shipments is delayed at a first route hub of the plurality of route hubs, wherein the current location comprises the first route hub; and
determine, based on the at least one existing shipment being delayed, and based on the at least one survival model, the on-time delivery prediction for the at least one existing shipment.

15. The apparatus of claim 9, wherein the processor-executable instructions further cause the apparatus to at least one of:
append, to the first shipment metadata, the level of confidence associated with the expected delivery date/time;
associate the first shipment identifier with a second route identifier, wherein the second route identifier is associated with at least one route hub of the plurality of route hubs;
modify a shipment priority associated with the first shipment identifier;
modify a shipping courier identifier associated with the first shipment identifier; or
modify the expected delivery time/date.

16. The apparatus of claim 9, wherein the at least one survival model comprises a Kaplan-Meier survival algorithm.

17. A non-transitory computer-readable medium storing processor-executable instructions that, when executed by at least one processor of a computing device, cause the computing device to:
receive a first shipment identifier and first shipment metadata, wherein the first shipment metadata comprises a dispatch date/time, an expected delivery date/time, and a first route identifier associated with a plurality of route hubs;
determine, based on the first route identifier, a plurality of existing shipment identifiers for a plurality of existing shipments associated with the plurality of route hubs;
determine, by at least one survival model, based on shipment metadata associated with the plurality of existing shipment identifiers, an on-time delivery prediction for each of the plurality of existing shipments at each of the plurality of route hubs; and
determine, by the at least one survival model, based on:
the dispatch date/time,
the expected delivery date/time,
a current location of the first shipment, wherein the current location comprises one of the plurality of route hubs, and
the on-time delivery prediction for each of the plurality of existing shipments at each of the plurality of route hubs,
a first on-time delivery prediction for the first shipment, wherein the first on-time delivery prediction comprises a level of confidence associated with the expected delivery date/time.

18. The non-transitory computer-readable medium of claim 17, wherein the processor-executable instructions that cause the computing device to determine the on-time delivery prediction for each of the plurality of existing shipments at each of the plurality of route hubs further cause the computing device to:
receiving, at a threshold interval, a plurality of updates to the shipment metadata associated with the plurality of existing shipment identifiers; and
determining, for each of the plurality of existing shipments at each of the plurality of route hubs, based on the plurality of updates, and based on a plurality of expected delivery dates/times associated with the plurality of existing shipments, a level of confidence for each of the plurality of expected delivery dates/times.

19. The non-transitory computer-readable medium of claim 18, wherein the threshold interval comprises at least one of a static refresh interval or a dynamic refresh interval.

20. The non-transitory computer-readable medium of claim 18, wherein the plurality of updates comprises at least one of: an indication of a delay, an indication of a loss, an indication of an arrival at a route hub of the plurality of route hubs, or an indication of a departure from a route hub of the plurality of route hubs.
